(19) United States
(12) Patent Application Publication
(10) Pub. No.: US 2005/0159316 A1
(43) Pub. Date: Jul. 21, 2005

(54) Ingredients and manufacturing method of water dispersible pesticide granules

(76) Inventors: Chia-Chung Chen, Caotun Township (CN); Che-Cheng Lin, Chaojhou Township (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/758,190

(22) Filed: Jan. 16, 2004

(51) Int. Cl. A01N 25/12

(52) U.S. Cl. 504/367

(57) ABSTRACT

A water dispersible granule includes the ingredients of wetting agent, dispersing agent, binder, disintegratant, acid, base, carrier and pesticide, wherein the above ingredients are combined to be 100%. All the above components of insecticide are mixed with water and extruded. The extruded material is baked in an oven that has operation temperature set from 40° C. to 50° C. and the baked material ground into small granules by machine or manpower.

### BACKGROUND OF THE INVENTION

1. Field of the Invention

The present invention relates to ingredients and a manufacturing method of pesticide granules, and more particularly to ingredients and a manufacturing method of water dispersible pesticide granules.

2. Description of Related Art

The solid pesticide, that is hard to be dissolved in water or organic solvent, is made as a wettable powder. As investigating the production and marketing of wettable powder of pesticide in Taiwan in 2002, the total output is 1,951,576 Kg. However, the dust of wettable powder easily floats in the air and causes a bad influence upon the user and the environment. Consequently, how to alter the wettable powder of pesticide into water dispersible granules is the most important objective of the pesticide manufacturer.

The conventional method for manufacturing water dispersible pesticide granules is to compress and dry the ingredients of the water dispersible pesticide granules at temperature 50° C. to 130° C. In best mode, the operate temperature is set from 75° C. to 115° C.

In the conventional method, a chemical stabilizer is necessary to prevent the ingredients from deteriorating in the high temperature. However, the chemical stabilizer may reduce the efficacy of the pesticides.

The present invention has arisen to mitigate and/or obviate the disadvantages of the conventional method for manufacturing water dispersible pesticide granules.

### SUMMARY OF THE INVENTION

The main objective of the present invention is to provide an improved ingredient and manufacturing method of water dispersible pesticide granules.

To achieve the objective, a water dispersible granule in accordance with the present invention comprises the ingredients of wetting agent, dispersing agent, binder, disintegratant, acid, base, carrier and pesticide, wherein the above ingredients are combined to be 100%. All the above components of pesticide are mixed with water and extruded. The extruded material is baked in an oven that has operation temperature set from 40° C. to 50° C. and the baked material ground into small granules by machine or manpower.

Further benefits and advantages of the present invention will become apparent after a careful reading of the detailed description with appropriate reference to the accompanying drawings.

### DETAILED DESCRIPTION OF THE INVENTION

The ingredients of the water dispersible granules in accordance with the present invention comprises:
a. wetting agent contained 0.01-5%, in the preferred embodiment of the present invention, wherein the wetting agent is alkylated naphthalene sulfonate blend (EFW, Manufacturer: Witco U.S.) and the inclusion rate is best to be 2.25%;
b. dispersing agent contained 0.01-20%, in the preferred embodiment of the present invention, wherein the dispersing agent is naphthalene sulfonate condensate (D-425, Manufacturer: Witco U.S.) and the inclusion rate is best to be 2.25%;
c. binder contained 0.1-30%, in the preferred embodiment of the present invention, wherein the binder is sodium lignosulfonate and the inclusion rate is best to be 6.5%;
d. disintegratant contained 0.1-30%, in the preferred embodiment of the present invention, wherein the disintegratant is Na₂SO₄ and the inclusion rate is best to be 11%.
e. acid contained 0.01-10%;
f. base contained 0.01-10%;
g. carrier contained 0.01-80%; and
h. pesticide contained 0.01-90%, in the preferred embodiment of the present invention, wherein the total rate of the ingredients of e, f, g and h is best to be 78%.

The acid of the present invention is selected from one of the benzoic acid (C₆H₅COOH), p-hydroxy benzoic acid (p-HO—C₆H₅COOH), succinic acid (HOOCCH₂CH₂COOH), succinic anhydride (OCCH₂CH₂COO), phthalic acid (C₆H₄(COOH)₂), phthalic anhydride (C₆H₄(CO)₂O) and citric acid (C₃H₄(OH)(COOH)₃). In the preferred embodiment of the present invention, the acid is benzoic acid and has a inclusion rate about 4.5-7% by weight.

The base of the present invention is selected from one of the sodium carbonate (Na₂CO₃), sodium bicarbonate (NaHCO₃), potassium carbonate (K₂CO₃), potassium bicarbonate (KHCO₃) and calcium carbonate (CaCO₃). In the preferred embodiment of the present invention, the base is sodium carbonate and has a inclusion rate of 2.25-4% by weight.

All the pesticides in the form of wettable powder (WP) can be used as the pesticides of the present invention. According to the Pesticide Manual issued by the Council of Agriculture, Taiwan, the WP of the present invention is selected from one of the following ingredients, such as carbosulfan, BPMC, triadimfon, triadimefon, tricyclazole, dicloran, pirimicarb, bitertanol, carbaryl, sulfur, chlorothalonil, buprofezin, thiophanate-methyl, propineb, dodine, propoxur, bromacil, metaldehyde, thiabendazole, pencyouron, fenitrothion, procymidone, propargite, fthalide, CPMC, mancozeb, mancozeb+cymoxanil, mancozeb+metalaxyl, maneb, mancozeb+oxadixyl, cyromazine, triflumizole, myclobutanil, dazomet, oxythioquinox, copper oxychloride, MIPC, dithianon, MIPC+chlorpyrifos, thiocyclam hydrogen oxalate, benomyl, quinclorac, oxine-copper+thiophanate-methyl, oxine-copper, diafenthiuron, iprodione, carbendazim, bordeaux mixture, MTMC, fenvalerate, fenbutatin-oxide, niclosamide, cuprous oxide, copper hydroxide+oxine-copper, copper oxychloride+metalaxyl, dichlofluanid, phosmet, atrazine, malathion, TMTD, copper hydroxide, thiodicarb, tolclofos-methyl, propazine, ditalimfos, XMC, mepronil, napropamide, propineb+oxadixyl, phosalone, diuron, oxycarboxin, flutolanil, phosphamidon, fosetyl-aluminum, acephate, carbofuran, methomyl, ametryne, azinphos-methyl, bensultap, permethrin, cypermethrin, dicofol, fenbutatin-oxide+dicofol, clilorothalonil+thiophanate methyl, fosetyl-aluminum+chlorothalonil, propineb+thiophanate methyl, propineb+polyoxins B, propineb+oxadixyl, thiophanate methyl+streptomycin, tecloftalam, metiram+cymoxanil, benomyl+thiram, oxine-copper+cymoxanil, oxine-copper+metalaxyl, carbendazim+iprodione, carbendazim+imazalil, carbendazim+metiram, carbendazim+mepronil, carbendazim+hexaconazole, polyoxins+oxine-copper, polyoxins+thiophanate methyl, polyoxins B, fermizone+fthalide, hexaconazole+thiabendazole, diniconazole, kasugamycin+tricyclazole, edifenphos+fthalide, kasugamycin+oxine-copper, kasugamycin+carbendazim, kasugamycin, kasugamycin+copper oxychloride, kasugamycin+fthalide, fosetyl-aluminum+oxine-copper, thiabendazole+oxine-copper, vakidamycin+fthalide, fonofos+cypermethrin, buprofezin+MIPC, esfenvalerate+buprofezin, phosmet+carbofuran, phosmet+cypermethrin, pyraclofos, methomyl+flucythrinate, pymetrozine, chlorpyrifos, carbofuran+fonofos and cyromazine.

The following samples are the prescriptions that the WP respectively is from one of the pencycuron, chlorothalonil, benomyl and carbaryl.

The prescription is as the table 1 when the active ingredient of the WP is pencycuron.

TABLE 1

| Components | % |
|---|---|
| EFW | 2.25 |
| D-425 | 2.25 |
| Sodium lignosulfonate | 6.5 |
| Na₂SO₄ | 11 |
| Pencycuron | 25 |
| C₆H₅COOH | 5.75 |
| Na₂CO₃ | 2.25 |
| Clay Powder (Continental Clay) | 45 |
| Total | 100 |

The testing result of the table 1:

| | |
|---|---|
| Dispersibility (%) | 85.27 |
| Abrasion rate (%) | 0.01 |
| Suspensibility (%) | 77.26 |
| Disintegration time (second) | 96 |

After storing at temperature 54° C. for two weeks, the active ingredient decomposed for 4.16%.

The prescription is as the table 2 when the active ingredient of WP is chlorothalonil.

TABLE 2

| Components | % |
|---|---|
| EFW | 2.25 |
| D-425 | 2.25 |
| Sodium lignosulfonate | 6.5 |
| Na₂SO₄ | 11 |
| Chlorothalonil | 60 |
| C₆H₅COOH | 5.75 |
| Na₂CO₃ | 2.25 |
| Clay Powder (Continental Clay) | 10 |
| Total | 100 |

| | |
|---|---|
| Dispersibility (%) | 74.77 |
| Abrasion rate (%) | 0.02 |
| Suspensibility (%) | 72.32 |
| Disintegration time (second) | 53 |

After storing at temperature 54° C. for two weeks, the active ingredient decomposed for 1.06%.

The prescription is as the table 3 when the active ingredient of the WP is benomyl.

TABLE 3

| Components | % |
|---|---|
| EFW | 2.25 |
| D-425 | 2.25 |
| Sodium lignosulfonate | 6.5 |
| Na₂SO₄ | 11 |
| Benomyl | 50 |
| C₆H₅COOH | 5.75 |
| Na₂CO₃ | 2.25 |
| Clay Powder (Continental Clay) | 20 |
| Total | 100 |

The testing result of the table 3:

| | |
|---|---|
| Dispersibility (%) | 81.86 |
| Abrasion rate (%) | 0.04 |
| Suspensibility (%) | 73.53 |
| Disintegration time (second) | 132 |

After storing at temperature 54° C. for two weeks, the active ingredient decomposed for 5.01%.

The prescription is as the table 4 when the active ingredient of the WP is carbaryl.

TABLE 4

| Components | % |
|---|---|
| EFW | 2.25 |
| D-425 | 2.25 |
| Sodium lignosulfonate | 6.5 |
| Na₂SO₄ | 11 |
| Carbaryl | 65 |
| C₆H₅COOH | 5.75 |
| Na₂CO₃ | 2.25 |
| Clay Powder (Continental Clay) | 5 |
| Total | 100 |

The testing result of the table 4:

| | |
|---|---|
| Dispersibility (%) | 77.1 |
| Abrasion rate (%) | 0.04 |
| Suspensibility (%) | 74.62 |
| Disintegration time (second) | 83 |

After storing at temperature 54° C. for two weeks, the active ingredient decomposed for 5.05%.

The manufacturing method of water dispersible pesticide granules in accordance with the present invention comprises the following steps:

Step A: All the components of pesticide are mixed with water and extruded by a twin-screw extruding machine.

Step B: The extruded material is baked in an oven that has operation temperature set from 40° C. to 50° C.

Step C: The baked material is ground into small granules by machine or manpower.

Step D: The granules are selected and each has a diameter between 0.3 mm to 0.8 mm. The select method is to use a first screen mesh and a second screen mesh respectively having a mesh that is 0.840 mm and 0.279 mm. The granules pass through the first screen mesh and are remained on the second screen mesh.

The chemical stabilizer is unnecessary to the present invention because the operation temperature of he present invention is set from 40° C. to 50° C. Furthermore, the benzoic acid and sodium carbonate are contained in the present invention such that a neutralization is cause due to the benzoic acid and sodium carbonate when the water dispersible granules are put into water. The chemical formula of neutralization is:
2C₆H₅COOH+Na₂CO₃ CO₂+2C₆H₅COONa+H₂O
The bubbles of carbon dioxide will cause functions of collapsing and stirring in the water to speed up the disintegration rate of the water dispersible pesticide granules in accordance with the present invention.

An experiment is enforced to confirm the time for fully dissolving the water dispersible pesticide granules of the present invention. The water dispersible pesticide granules of the present invention are input into a container that is full of water. The container is reversed after inputting the water dispersible pesticide granules for five seconds and repeated reversing the container every four seconds. As a result, the water dispersible pesticide granules of the present invention are fully disintegrated in fourteen seconds. However, the conventional water dispersible pesticide granules without acid and base take about forty-five seconds for fully disintegration.

As described above, the water dispersible pesticide granules of the present invention has a good water dispersible property. A high-temperature process is unnecessary to the manufacturing method of present invention, that is, the stabilizer is unnecessary to the present invention. Consequently, the property and the efficacy of the active ingredients of pesticide are ensured.

Although the invention has been explained in relation to its preferred embodiment, it is to be understood that many other possible modifications and variations can be made without departing from the spirit and scope of the invention as hereinafter claimed.

1. Water dispersible granules comprising the ingredients of:
wetting agent contained 0.01-5%;
dispersing agent contained 0.01-20%;
binder contained 0.1-30%;
disintegratant contained 0.1-30%;
acid contained 0.01-10%;
base contained 0.01-10%;
carrier contained 0.01-80%; and
pesticide contained 0.01-90%, wherein the above ingredients are combined to be 100%.

2. The water dispersible granules as claimed in claim 1, wherein the total rate of the acid, the base, the carrier and the pesticide is to be 78%.

3. The water dispersible granules as claimed in claim 1, wherein the acid is selected from one of the benzoic acid, p-hydroxy benzoic acid, succinic acid, succinic anhydride, phthalic acid, phthalic anhydride and citric acid.

4. The water dispersible granules as claimed in claim 1, wherein the base is selected from one of the sodium carbonate, sodium bicarbonate, potassium carbonate, potassium bicarbonate and calcium carbonate.

5. The water dispersible granules as claimed in claim 2, wherein the acid is selected from one of the benzoic acid, p-hydroxy benzoic acid, succinic acid, succinic anhydride, phthalic acid, phthalic anhydride and citric acid.

6. The water dispersible granules as claimed in claim 2, wherein the base is selected from one of the sodium carbonate, sodium bicarbonate, potassium carbonate, potassium bicarbonate and calcium carbonate.

7. The water dispersible granules as claimed in claim 3, wherein the base is selected from one of the sodium carbonate, sodium bicarbonate, potassium carbonate, potassium bicarbonate and calcium carbonate.

8. The water dispersible granules as claimed in claim 3, wherein the acid is benzoic acid and has a weight rate about 4.5-7%.

9. The water dispersible granules as claimed in claim 4, wherein the base is sodium carbonate and has a weight about 2.25-4%.

10. The water dispersible granules as claimed in claim 5, wherein the acid is benzoic acid and has a weight rate about 4.5-7%.

11. The water dispersible granules as claimed in claim 6, wherein the base is sodium carbonate and has a weight about 2.25-4%.

12. The water dispersible granules as claimed in claim 7, wherein the base is sodium carbonate and has a weight about 2.25-4%.

13. A manufacturing method of water dispersible pesticide granules comprises the steps of:
step A: all the components of pesticide mixed with water and extruded;
step B: the extruded material baked in an oven that has operation temperature set from 40° C. to 50° C.; and
step C: the baked material ground into small granules by machine or manpower.

14. The manufacturing method of water dispersible pesticide granules as claimed in claim 13, wherein the granules are selected and each has a diameter between 0.3 mm to 0.8 mm.

15. The manufacturing method of water dispersible pesticide granules as claimed in claim 13, wherein the water dispersible granules comprising the ingredients of:
wetting agent contained 0.01-5%;
dispersing agent contained 0.01-20%;
binder contained 0.1-30%;
disintegratant contained 0.1-30%;
acid 0.01-10%;
base contained 0.01-10%;
carrier contained 0.01-80%; and
pesticide contained 0.01-90%.

16. The manufacturing method of water dispersible pesticide granules as claimed in claim 13, wherein the components of the pesticide is extruded by a twin-screw extruding machine.

17. The manufacturing method of water dispersible pesticide granules as claimed in claim 14 comprises a select method that uses a first screen mesh and a second screen mesh respectively having a mesh that is 0.840 mm and 0.279 mm. The granules pass through the first screen mesh and are remained on the second screen mesh.
